(19) United States
(12) Patent Application Publication
(10) Pub. No.: US 2015/0109408 A1
(43) Pub. Date: Apr. 23, 2015

(54) SYSTEM AND METHOD FOR CAPTURING AND RENDERING A LANDSCAPE IMAGE OR VIDEO

(71) Applicant: STMicroelectronics International N.V., Amsterdam (NL)

(72) Inventors: Amit Sharma, Noida (IN); Gaurav Jairath, Delhi (IN); Paramanand Singh, Noida (IN)

(73) Assignee: STMicroelectronics International N.V., Amsterdam (NL)

(21) Appl. No.: 14/058,794

(22) Filed: Oct. 21, 2013

(51) Int. Cl. H04N 5/232

(52) U.S. Cl. CPC H04N 5/23216; H04N 5/23245; H04N 5/23296
USPC 348/39

(57) ABSTRACT

The present disclosure provides a system and method for capturing and rendering a landscape image such that the field of view of the captured image remains consistent across any orientation maintained by the camera device at the time the image is captured. The retained field of view corresponds to the maximum landscape field of view achievable from the aspect ratio of the image when captured by the device, when the device is positioned in portrait orientation. Thus, the field of view of a landscape image captured when the camera device is positioned in landscape orientation is identical to the field of view of a landscape image captured when the device is positioned in portrait orientation. Furthermore, the system and method provide for a consistent field of view at the time of playback regardless of whether the captured image is displayed on a device having a portrait or landscape display orientation.

### FIELD OF THE INVENTION

The present disclosure relates to a system and method for capturing and rendering a landscape image/video, while retaining a same field of view, regardless of the orientation or rotation of the camera device.

### BACKGROUND

When capturing images (e.g., video or still frame images), a camera device (e.g., smartphone, tablet, or any other device incorporating a camera) may be positioned such that the device captures images in either a portrait mode or a landscape mode. Images captured in portrait mode (i.e., portrait images) have a portrait orientation (that is, an orientation where the height of the image is greater than the width), whereas images captured in the landscape mode (i.e., landscape images) have a landscape orientation (an orientation where the width of the image is greater than the height). When capturing images in portrait mode, the camera device is typically positioned in a portrait orientation. Similarly, the device is generally positioned in landscape orientation to capture images in landscape mode. Generally, as a result of the physical characteristics of the device, orienting the device in portrait orientation to capture images is usually more convenient and comfortable for the user, particularly when the device (e.g., a smartphone) incorporates a display screen that has a portrait orientation, or when the device is otherwise constructed to have a height that is greater than its width.

An image/video captured in portrait or landscape mode may be viewed on a display in the opposite orientation than that in which it was captured. For example, a portrait image/video may be viewed in landscape mode, and a landscape image/video may be viewed in portrait mode. Usually, this is accomplished by rotating the captured image/video (+/−90° or) 180° as needed and resizing it to fit the dimensions of the viewing display. Because many viewing devices (such as computer monitors, televisions, etc.) now feature wide screen displays, images are more commonly viewed in landscape orientation. While this may be sufficient for images captured in landscape mode, images captured in portrait mode suffer greatly from reduced field of view when viewed in landscape orientation—usually as a result of mismatched aspect ratios occurring during the rotating/resizing process.

### SUMMARY

The present disclosure provides a method for rendering a landscape image of a scene captured by a camera device, the method comprising: operating in a first mode when the camera device is positioned in a portrait orientation, the first mode comprising: cropping a first capture of the scene, the first capture having a first aspect ratio, to produce a first cropped image having a second aspect ratio defining a field of view of the landscape image, and generating, from the first cropped image, the landscape image having the field of view defined by the first cropped image.

In another embodiment, the present disclosure provides a method for rendering a landscape image of a scene captured by a camera device, the landscape image having a first field of view when the landscape image is captured with the camera device positioned in a portrait orientation, and having a second field of view when the landscape image is captured with the camera device positioned in a landscape orientation, wherein the first field of view is substantially equal to the second field of view, the method comprising: operating in a first mode when the camera device is positioned in the portrait orientation, the first mode comprising: cropping a first capture of the scene, the first capture having a first aspect ratio, to produce a first cropped image having a second aspect ratio and defining the first field of view, and generating, from the first cropped image, the landscape image having the first field of view; and operating in a second mode when the camera device is positioned in the landscape orientation, the second mode comprising: performing a zoom operation to produce a magnified view of the scene, the magnified view of the scene defining the second field of view, wherein the second field of view is substantially equal to the first field of view, and generating, from the magnified view of the scene, the landscape image having the second field of view.

In yet another embodiment, the present disclosure provides one or more computer-readable media embodied with computer-executable instructions that, when executed by one or more processors, perform a computer-implemented method for rendering a landscape image of a scene captured by a camera device, the landscape image having a first field of view when the landscape image is captured with the camera device positioned in a portrait orientation, and having a second field of view when the landscape image is captured with the camera device positioned in a landscape orientation, wherein the first field of view is substantially equal to the second field of view, the method comprising: operating in a first mode when the camera device is positioned in the portrait orientation, the first mode comprising: cropping a first capture of the scene, the first capture having a first aspect ratio, to produce a first cropped image having a second aspect ratio and defining the first field of view, and generating, from the first cropped image, the landscape image having the first field of view; and operating in a second mode when the camera device is positioned in the landscape orientation, the second mode comprising: performing a zoom operation to produce a magnified view of the scene, the magnified view of the scene defining the second field of view, wherein the second field of view is substantially equal to the first field of view, and generating, from the magnified view of the scene, the landscape image having the second field of view.

In another embodiment, the present disclosure provides a device for rendering a landscape image of a scene, the device comprising: circuitry operable to determine an orientation of the device; an image sensor operable to capture an image of the scene exposed to the image sensor, the captured image having a sensor aspect ratio; and image processing circuitry operable in a first mode to: crop the captured image to produce a first cropped image having a second aspect ratio and defining a first field of view, and generate, from the first cropped image, the landscape image having the first field of view; wherein the image processing circuitry is further operable in a second mode to: perform a zoom operation to produce a magnified view of the scene, the magnified view of the scene defining the second field of view, wherein the second field of view is substantially equal to the first field of view, and generate, from the magnified view of the scene, the landscape image having the second field of view, wherein the image processing circuitry operates in the first mode when the device is positioned in a portrait orientation and operates in the second mode when the device is positioned in a landscape orientation.

The foregoing and other features and advantages of the present disclosure will become further apparent from the following detailed description of the embodiments, read in conjunction with the accompanying drawings. The detailed description and drawings are merely illustrative of the disclosure, rather than limiting the scope of the invention as defined by the appended claims and equivalents thereof.

### BRIEF DESCRIPTION OF DRAWINGS

Embodiments are illustrated by way of example in the accompanying figures not necessarily drawn to scale, in which like numbers indicate similar parts, and in which:

FIG. 1A illustrates various example components comprising an example camera device;

FIG. 1B illustrates example circuitry for processing and displaying data received from the image capture components described with respect to FIG. 1A;

FIGS. 2A, 2B, and 2C provide an overview illustration of the proposed and conventional methods for producing a landscape image when the camera device is positioned in portrait orientation;

FIGS. 3A, 3B, 3C, 3D, 3E, 3F, and 3G each illustrate an image in accordance with an example of a conventional method for capturing a landscape image/video when the device is positioned in a landscape orientation;

FIGS. 4A, 4B, 4C, 4D, 4E, 4F, 4G, 4H, 41, and 4J each illustrate an image in accordance with an example of a conventional method for capturing a landscape image/video when the device is positioned in a portrait orientation;

FIGS. 5A, 5B, and 5C illustrate flow diagrams showing various stages of image processing performed in accordance with various embodiments for generating a landscape image when the camera device is positioned in landscape orientation;

FIGS. 6A, 6B, 6C, 6D, 6E, 6F and 6G each illustrate an image corresponding to the image processing stages provided in FIG. 5;

FIG. 7 illustrates a flow diagram showing various stages of image processing performed when in accordance with the disclosed method for generating a landscape image when the camera device is positioned in portrait orientation;

FIGS. 8A, 8B, 8C, 8D, 8E and 8F each illustrate an image corresponding to the image processing stages provided in FIG. 7;

FIG. 9A illustrates an example of a landscape display area in accordance with an example embodiment of the present disclosure;

FIG. 9B illustrates an example of a portrait display area in accordance with an example embodiment of the present disclosure;

FIG. 9C illustrates an example of a chart that corresponds to a zoom performed based upon an example of a desired capture aspect ratio; and

FIG. 10 illustrates, in both portrait and landscape orientations, a scene exposed to a camera device sensor and the landscape image produced in accordance with the disclosed method for generating a landscape image.

### DETAILED DESCRIPTION OF THE EMBODIMENTS

The present disclosure provides a system and method for capturing and rendering a landscape image and/or video while retaining a same field of view (FOV) irrespective of the camera device's orientation (portrait or landscape). As discussed herein, the retained field of view corresponds to the maximum landscape field of view achievable from the aspect ratio of the image when captured by the device, when the device is positioned in portrait orientation.

The disclosed system and method substantially reduces, if not eliminates, additional image processing that is typically performed by conventional devices and techniques, which first capture a video or image in portrait mode and then crop the image to produce a landscape image/video using additional image processing software. In accordance with the present disclosure, the term landscape image or landscape video may be used herein to refer to an image or video that is ultimately intended to be viewed in landscape orientation, regardless of the orientation of the camera device when the image or video is captured. Unless explicitly stated otherwise, reference to “image” or “video” as used herein is intended to refer to either image data, video data, or a combination of both. Thus, the term “image,” as used herein, is interchangeable with “video” unless specifically stated otherwise. It should therefore be appreciated that the disclosed system and method may be used to capture and render both landscape images and landscape videos.

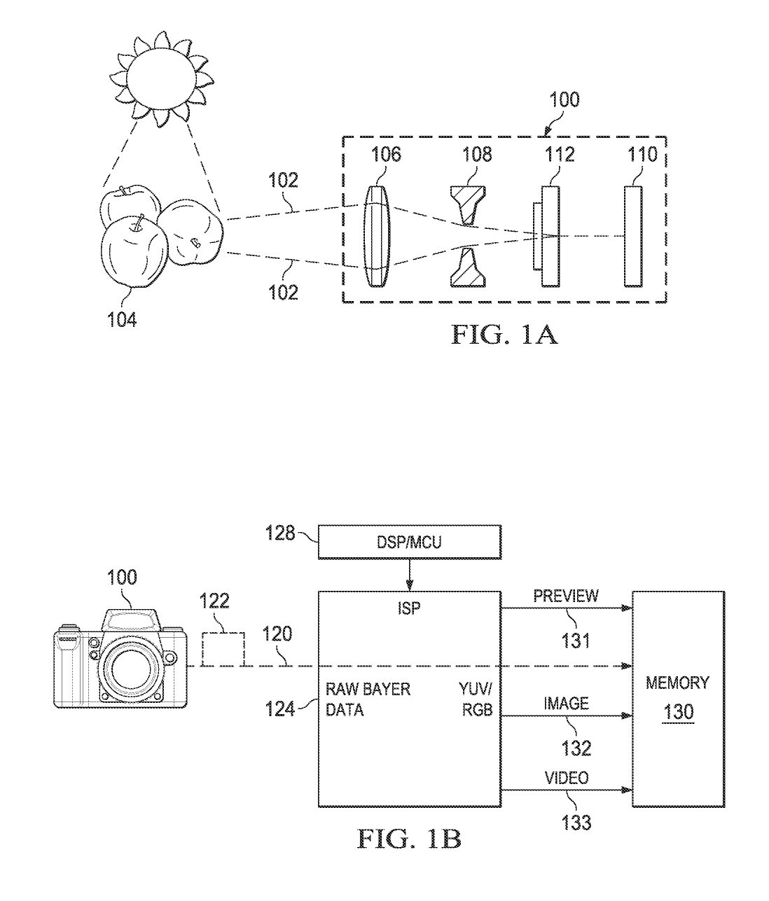

FIGS. 1A and 1B are provided in support of a brief overview description of the operation of an example camera device capable of capturing an image. Referring to FIG. 1A, which illustrates various example components 100 comprising the camera device, light 102 reflected off of an object 104 is received by a lens 106. The lens 106 is followed by an aperture 108, which adjusts to control the amount of light 102 that ultimately reaches an image sensor 110. A shutter 112 controls the amount of time that the image sensor 110 is exposed to the light 102 by opening to allow the light 102 to pass through to the image sensor 110 and closing to block the light 102 from reaching the image sensor 110. The image sensor 110 comprises a photosensitive material that absorbs the light 102 and converts it into an electronic signal used to determine the color of a pixel comprising a captured image of the object 104. Unless otherwise specified, the terms “sensor,” “image sensor,” or “camera sensor,” as used throughout the present disclosure correspond to the image sensor 110 of FIG. 1A, or one similar to the image sensor 110 of FIG. 1A.

FIG. 1B illustrates example circuitry for processing signals received in connection with the image capture components 100 described with respect to FIG. 1A. The electronic signal 120 provided by the image sensor 110 (see FIG. 1A) is passed to an image signal processor (ISP) 124 as image data 122, which may include Raw Bayer/YUV data. A digital signal processor (DSP) or microcontroller unit (MCU) 128 is used to control operation of the ISP 124. After receiving the image data 122, the ISP 124 performs a demosaicing (e.g., YUV/RGB), if needed, and other processing on the Raw Bayer/YUV data received from the image sensor 110, and stores the processed image data in memory 130. In some embodiments, the ISP 124 may comprise a single pipeline with one output containing all image data. In other embodiments, the ISP 124 may comprise a dual pipeline with one output for a viewfinder and another output for video/still image data. In yet another embodiment, such as that illustrated in FIG. 1B, the ISP 124 may comprise three pipelines with a first output pipeline 131 for preview data, a second output pipeline 132 for still image data, and a third output pipeline 133 for video data.

In the example embodiments discussed herein, functions or steps of the disclosed method may be described as being performed generally by “the camera device.” However, it should be appreciated that such statements are intended to mean that the functions or steps are performed by circuitry, such as that shown in FIGS. 1A and 1B and described above, which may be incorporated in the camera device itself or in one or more devices in addition to the camera device. Furthermore, various components of the camera device may be incorporated in use of the disclosed system, and may be used to implement the disclosed method. Such components may include, for example, a camera lens, gyroscope, accelerometer, display screen, image/video rendering/processing/recognition software, and other components involved in capturing, modifying, processing, and rendering image or video data. For example, a gyroscope may be used to determine the orientation of the camera device. Similarly, in some embodiments, image recognition software may be provided to identify objects in the scene to determine the orientation of the camera device. Such determination may dictate which steps are performed in the disclosed method for capturing and rendering a landscape image as further described below.

It should be appreciated that one or more elements of the disclosed system and method may be embodied as a software application (program, firmware, etc. . . . ) operating in connection with the camera device. The software may be operating locally on the camera device itself, operating remotely on a computer or other processing device, or some combination thereof. As such, it should be appreciated that at least one aspect of the disclosed system and method may be described in the general context of computer code or machine-useable instructions, including computer-executable instructions that include program components or modules stored in computer-storage media and being executed by a processor.

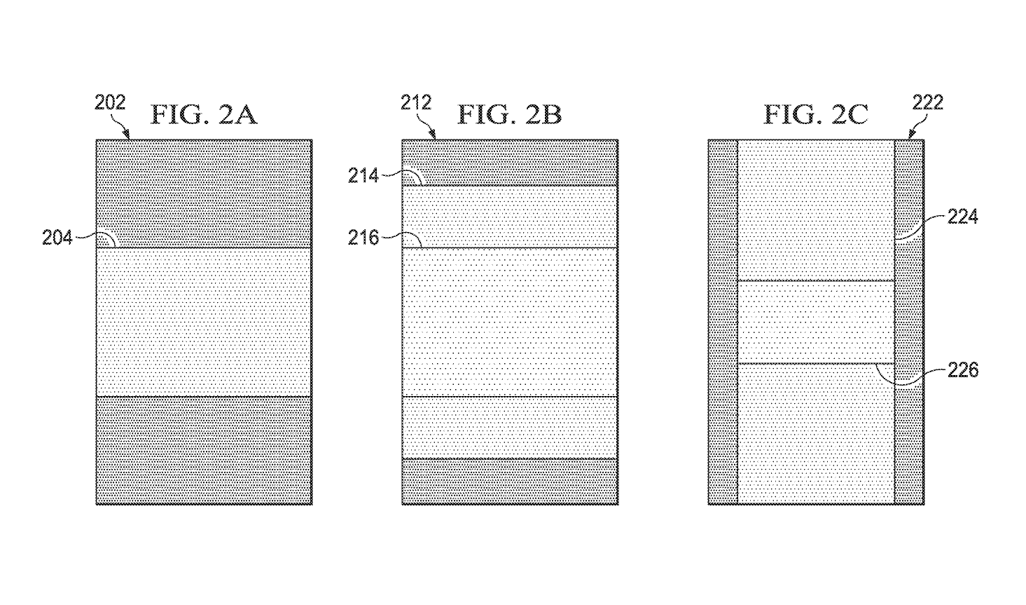

Before detailing the operations performed in the conventional and disclosed methods for producing a landscape image, reference is first made to FIGS. 2A-2C to provide a general overview of the proposed and conventional methods for producing a landscape image. FIG. 2A corresponds to the disclosed method for producing a landscape image, and FIGS. 2B and 2C correspond to conventional methods for producing portrait and landscape images. The embodiments illustrated in FIGS. 2A-2C assume an identical camera device oriented in portrait mode and having a same sensor aspect ratio. Regarding FIGS. 2B and 2C, FIG. 2B represents an embodiment in which the sensor aspect ratio 212 is greater than the capture aspect ratio 216, and FIG. 2C represents an embodiment in which the sensor aspect ratio 222 is less than the capture aspect ratio 226.

Referring now to FIG. 2A, reference 202 represents the dimensions of the sensor aspect ratio of the image sensor of the camera device when positioned in portrait orientation, and reference 204 represents the dimensions of the resulting landscape image captured in accordance with the disclosed method. Referring now to FIG. 2B, reference 212 represents the dimensions of the sensor aspect ratio of the image sensor of the camera device when positioned in portrait orientation, reference 214 represents the dimensions of a portrait image produced by a cropping of the sensor aspect ratio 212 (first crop), and reference 216 represents the dimensions of the landscape image resulting from a cropping of the portrait image 214 (second crop). Referring now to FIG. 2C, reference 222 represents the dimensions of the sensor aspect ratio of the image sensor of the camera device when positioned in portrait orientation, reference 224 represents the dimensions of a portrait image produced by a cropping of the sensor aspect ratio 222 (first crop), and reference 226 represents the dimensions of the landscape image resulting from a cropping of the portrait image 224 (second crop).

As will be apparent from the following disclosure, in embodiments in which the sensor aspect ratio that is less than the capture aspect ratio, the landscape image 204 resulting from the disclosed method has a greater field of view than the landscape image 226 resulting from the conventional method. In embodiments in which the sensor aspect ratio that is greater than the capture aspect ratio, the landscape image 204 has the same field of view as the landscape image 216 resulting from the conventional method.

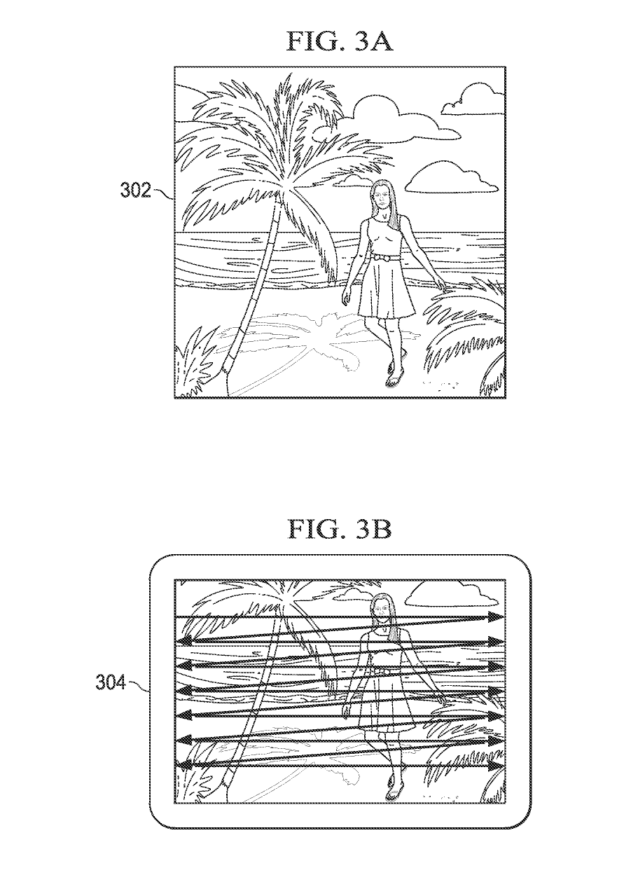

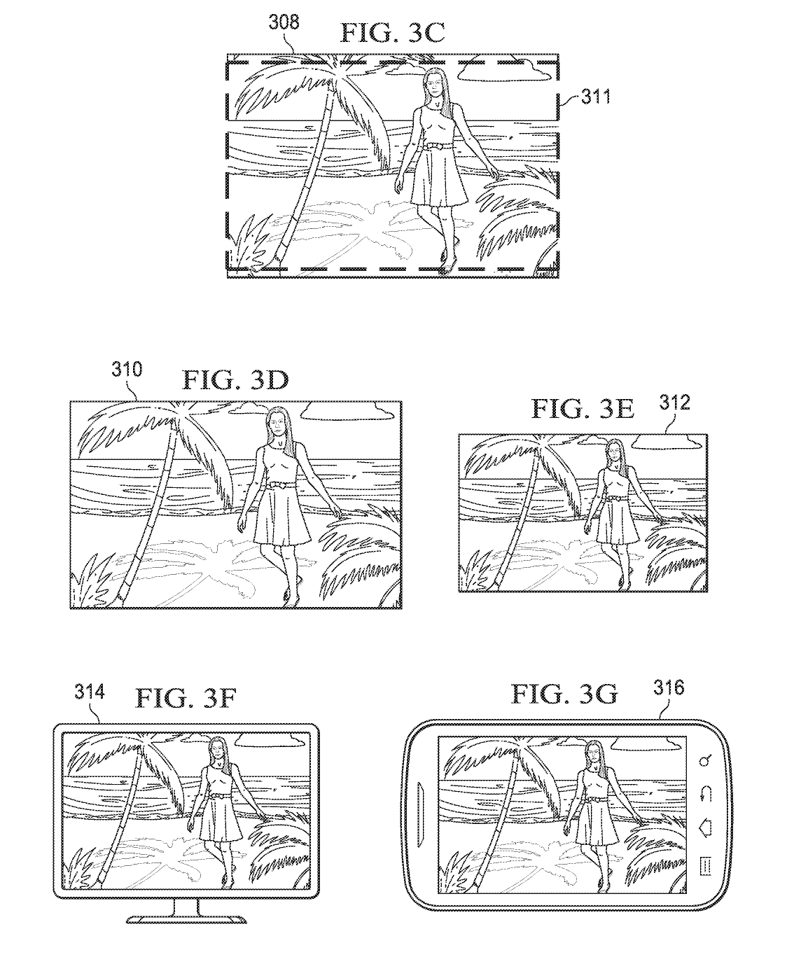

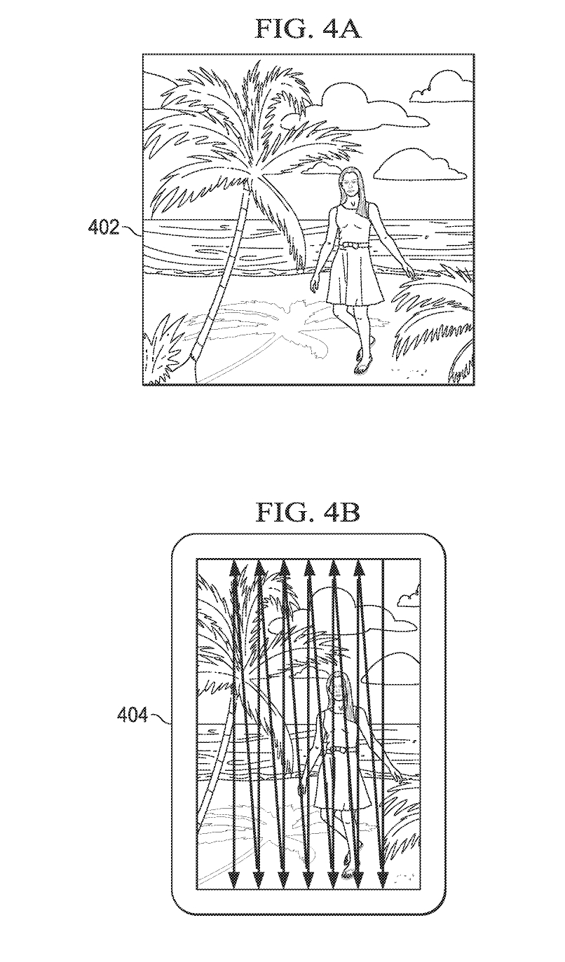

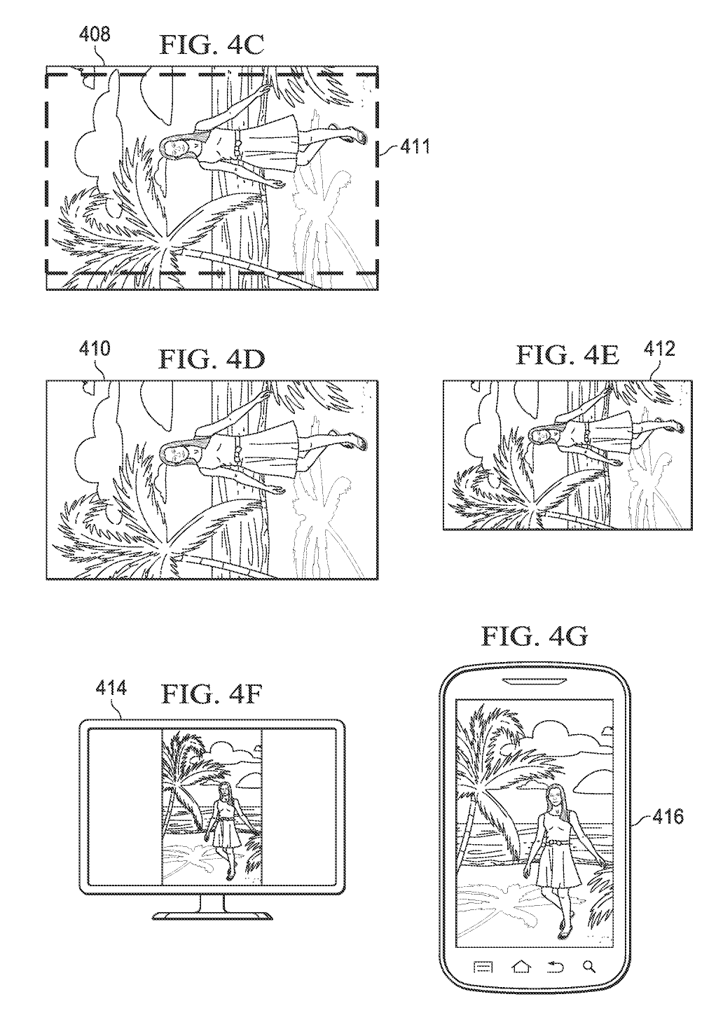

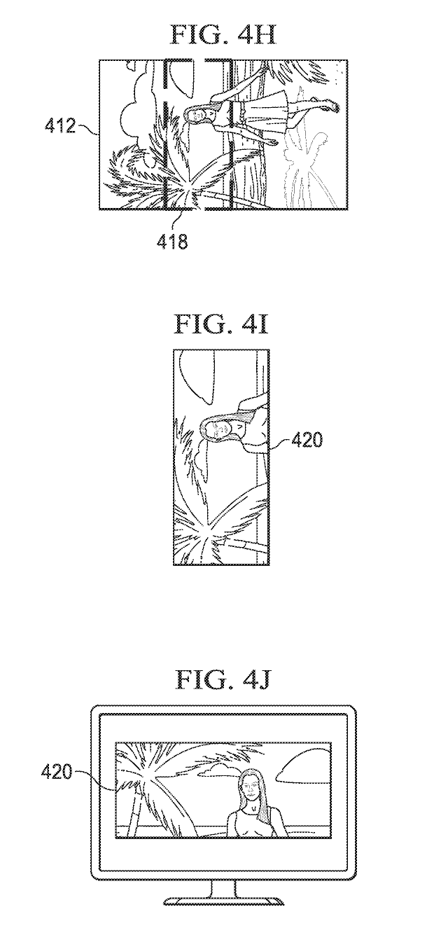

In the detailed discussion that follows, FIGS. 3A-3G and 4A-4J are provided to illustrate examples of conventional methods typically implemented to achieve a landscape image. FIGS. 3A-3G support an example of a conventional method used to capture a landscape image when the camera device is positioned in landscape orientation. FIGS. 4A-4J support an example of a conventional method used to capture a landscape image when the camera device is positioned in portrait orientation. As discussed more fully below, the landscape images produced using the conventional methods do not maintain a consistent field of view. Furthermore, when compared to a landscape image generated using the disclosed method, a landscape image derived from a portrait image using the conventional method suffers from a significantly reduced field of view.

Referring now to FIGS. 3A-3G, various images are shown in accordance with an example of a conventional method for rendering a landscape image when the device is positioned in a landscape orientation. Image 302 of FIG. 3A illustrates an example scene that is to be captured by a camera device. When capturing a landscape image using this conventional method, the device 304 is positioned in landscape orientation as shown in FIG. 3B. Image 308 of FIG. 3C illustrates a first capture of the scene exposed to the camera device's image sensor. In the example illustrated in FIG. 3C, the image sensor has a 3:2 aspect ratio, although it should be appreciated that sensors having other aspect ratios may be implemented in this and other embodiments disclosed herein.

Image 308 is cropped 311 to produce image 310 of FIG. 3D. In the example illustrated in FIGS. 3C and 3D, image 308 is cropped so that the resulting cropped image 310 has a 16:9 aspect ratio, although it should be appreciated that the image may be cropped to other dimensions.

Referring to FIG. 3E, captured image 312 shows the cropped image resized to the appropriate resolution while still retaining the specified aspect ratio. In some embodiments, the captured image may also be referred to as the captured buffer or captured frame. The captured image is the output of the ISP (e.g., ISP 124), which may be in the form of a still image, a video, or a preview frame, and is the image data that is stored or captured by the camera device. In some embodiments the cropping and resizing performed to obtain the captured image 312 depends upon the resolution and aspect ratio of the device sensor, as well as the capture dimensions specified by the system. In some embodiments, the captured image 312 may be rotated or otherwise altered prior to being stored.

Finally, FIGS. 3F and 3G illustrate the captured image 312 as it appears displayed on various devices for playback. FIG. 3F illustrates the image playback on a wide screen display 314 such as a monitor or television console. FIG. 3G illustrates the image playback on a smartphone 316, which, in some embodiments, may also be the camera device that captured the image 312. In both FIGS. 3F and 3G, the image is shown having an aspect ratio of 16:9.

Referring now to FIGS. 4A-4J, various images are shown in accordance with an example of a conventional method for capturing and rendering a landscape image when the device is positioned in a portrait orientation. The method discussed in connection with FIGS. 4A-4J generally involves a two-phase process: generating a portrait image, and then cropping the portrait image to generate a landscape image. FIGS. 4A-4G correspond to the steps performed in the first phase to obtain the portrait image, and FIGS. 4H-4J correspond to the steps performed in the second phase to obtain the landscape image.

Because the example image sensor aspect ratio (3:2) used in FIGS. 4A-4J is less than the example desired capture aspect ratio (16:9), the embodiment illustrated in FIGS. 4A-4J is similar to that generally illustrated in FIG. 2C. However, if the example sensor aspect ratio used in FIGS. 4A-4J was greater than the desired capture aspect ratio, then the embodiment illustrated in FIGS. 4A-4J would be similar to that generally illustrated in FIG. 2B. It is important to note that the actual steps performed for either embodiment of the conventional method are identical—namely, generating a portrait, or intermediate, image and then cropping the portrait (intermediate) image to generate the landscape image. However, the field of view of the resulting landscape image is different, as illustrated in FIGS. 2B and 2C.

Referring to FIG. 4A, image 402 illustrates an example scene that is to be captured by the camera device. When capturing a portrait image, the device 404 is positioned in portrait orientation as shown in FIG. 4B. Image 408 of FIG. 4C illustrates a first capture of the scene exposed to the camera device's image sensor.

In the example illustrated in FIG. 4C, the sensor has a 3:2 aspect ratio. Therefore, due to the rotation of the device 404 (and, consequently, the image sensor) as shown in FIG. 4B, the image 408 shown in FIG. 4C appears rotated. Image 408 is first cropped 411 to produce cropped image 410 of FIG. 4D. In the example illustrated in FIG. 4D, image 408 is cropped so that the resulting image 410 has a 16:9 aspect ratio, which is a landscape aspect ratio. Again, it should be appreciated that the image may be cropped to other dimensions. The cropped image 410 corresponds to the portrait image 224 in FIG. 2C.

As shown in FIG. 4E, the cropped image 410 is resized to the appropriate resolution while still retaining the specified landscape aspect ratio (16:9) to produce the captured image 412. The captured image 412, which is intended to be output as a portrait image, is shown in FIG. 4E as again having a landscape orientation and, therefore, appears inverted or rotated. As such, the image 412 will need to be rotated to appear with the proper orientation during playback. In some embodiments, the camera device may rotate and store the image 412 in portrait orientation, if such rotation is supported by the device. In other embodiments, the rotation and/or resizing of the capture image 412 may be performed by the device displaying the image 412, or by using some other image processing means. Regardless, the cropping and resizing of the image depends upon the resolution and aspect ratio of the device sensor, as well as the capture dimensions specified by the system.

FIGS. 4F and 4G illustrate the captured image as it appears on various devices for playback. FIG. 4F illustrates the image playback on a widescreen display 414 in portrait orientation and having an aspect ratio of 9:16. FIG. 4G illustrates the image playback on a smartphone 416, wherein the image is displayed in portrait orientation and having an aspect ratio of 9:16.

FIGS. 4H-4J demonstrate an example embodiment of a conventional method for performing the second-phase, wherein the captured image 412 of FIG. 4E is converted into a landscape image using additional image processing. As shown in FIG. 4H, the image 412, which has previously been cropped and resized for portrait orientation, is further cropped 418 to a 9:16 aspect ratio to produce image 420 shown in FIG. 4I. The second cropped image 420 corresponds to the landscape image 226 in FIG. 2C. To display in landscape orientation, image 420 is rotated so that it has an aspect ratio of 16:9, and can therefore be viewed in landscape as shown in FIG. 4J. When compared to the landscape image 312 shown in FIG. 3E, the landscape image 420 shown in FIG. 4J has a significantly reduced field of view.

The present disclosure provides a system and method for capturing and rendering a landscape image and/or video such that the field of view of the captured image remains consistent across any orientation maintained by the camera device at the time the image is captured. In other words, the field of view of a landscape image captured when the camera device is positioned in landscape orientation is identical to the field of view of a landscape image captured when the camera device is positioned in portrait orientation. Furthermore, the system and method provide for a consistent field of view at the time of playback regardless of whether the captured image (or video) is being displayed on a device having a portrait or landscape display orientation.

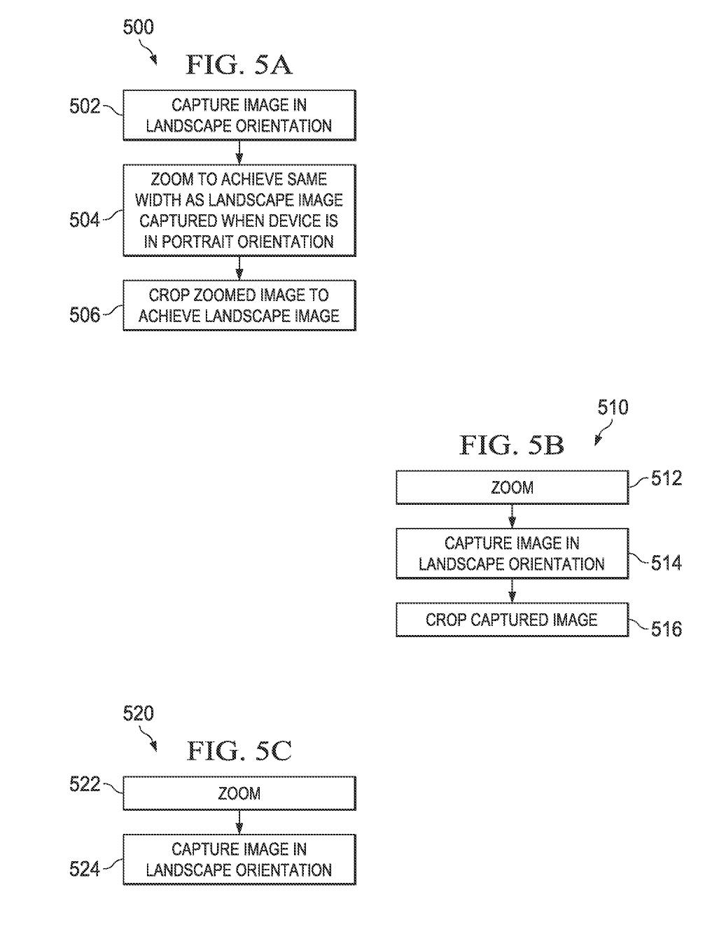

In order to maintain a field of view that is consistent across both camera device orientations, specific image processing is performed for each of the camera device orientations—landscape and portrait. For example, FIG. 5A illustrates a flow diagram 500 showing various stages of image processing performed when the image is captured with the device positioned in landscape orientation. Similarly, FIG. 7 illustrates a flow diagram 700 showing various stages of image processing performed when the image is captured with the device positioned in portrait orientation.

The image processing discussed with respect to FIG. 7 is intended to produce a landscape image having an increased field of view when compared to the field of view of landscape images obtained via conventional techniques, such as in the example discussed above with respect to FIGS. 4A-4J. The image processing discussed with respect to FIGS. 5A-5C is intended to produce a landscape image having a same field of view as that obtained via the image processing discussed with respect to FIG. 7.

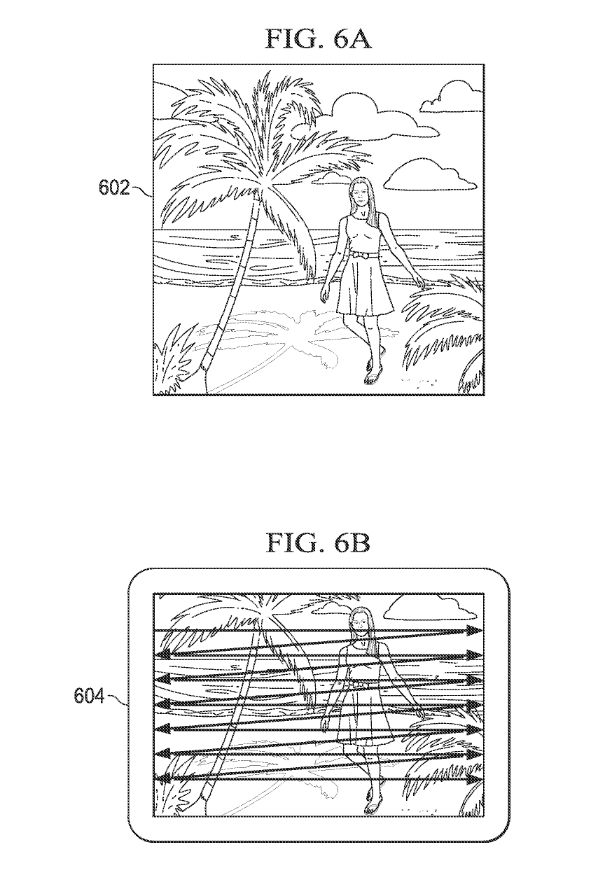

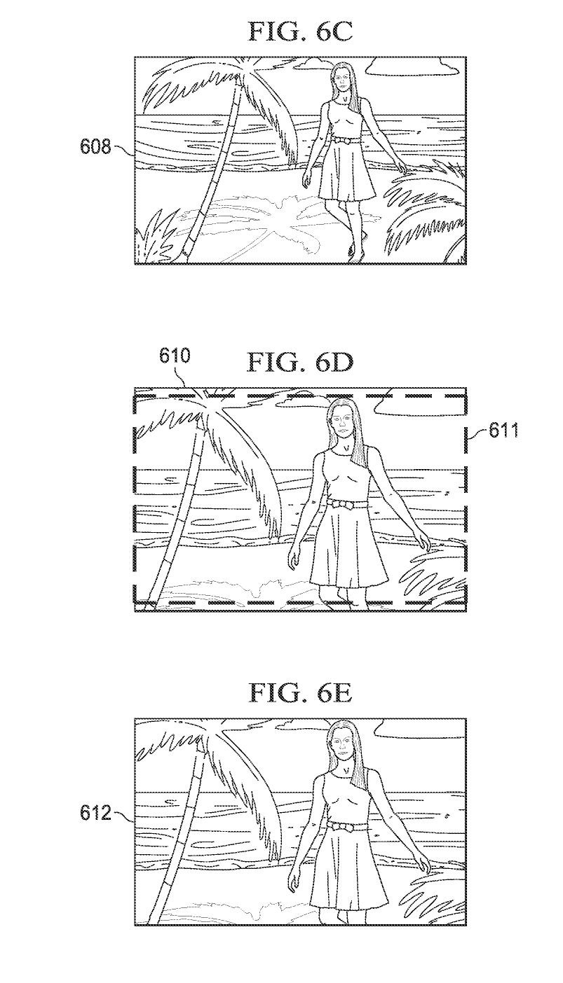

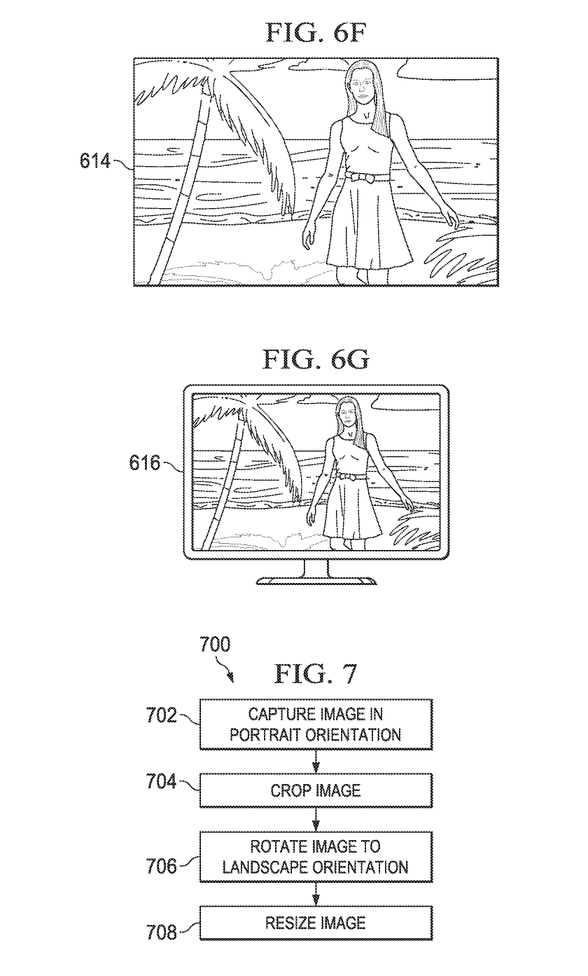

The image processing stages of FIG. 5A are discussed in greater detail below with reference to FIGS. 6A-6G, which each illustrate an image corresponding to the image processing stages provided in FIG. 5A. Accordingly, the disclosed method for capturing and rendering a landscape image and/or video with the camera device positioned in a landscape orientation is described below with reference to FIGS. 5A and 6A-6G.

Referring briefly to the flow diagram 500 in FIG. 5A, an image is captured in landscape orientation at 502. Referring now to FIG. 6A, image 602 illustrates an example scene that is to be captured by the camera device, wherein the device 604 is positioned in landscape orientation as shown in FIG. 6B. Image 608 of FIG. 6C illustrates a first capture of the scene exposed to the device's image sensor. In the example illustrated in FIG. 6C, the sensor has a 3:2 aspect ratio (also referred to herein as the sensor aspect ratio), although it should be appreciated that sensors having other aspect ratios (e.g., 1:1) may be implemented.

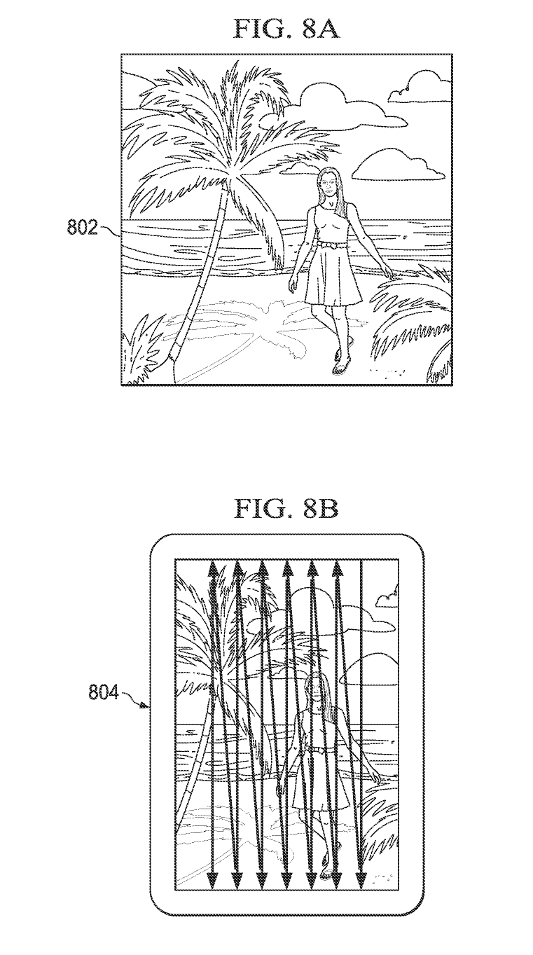

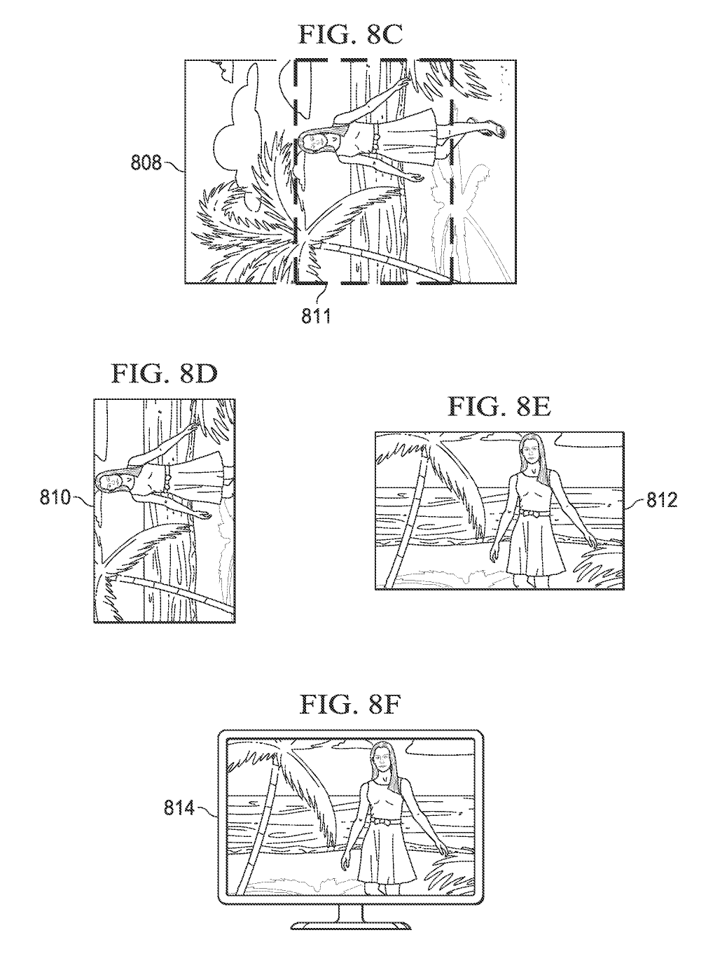

In accordance with 504 of FIG. 5A, the camera device performs a zoom operation (also referred to herein as a magnification) to produce a magnified view of the scene exposed to the sensor, to thereby achieve a particular field of view. The particular field of view achieved by the zoom operation is equal to the width of the field of view of the landscape image captured using the disclosed method when the device is positioned in portrait orientation (this is later discussed in greater detail with reference to FIGS. 8A-8F). As explained more fully below, the value of the zoom, or magnification, is determined based upon a comparison of the sensor aspect ratio and a desired capture aspect ratio of the landscape image (i.e., the aspect ratio of the final, captured image).

Generally, the zoom performed is equal to the lesser of the desired capture aspect ratio and the sensor aspect ratio. In other words, if the sensor aspect ratio is less than the desired capture aspect ratio, then the zoom is equal to the sensor aspect ratio. If the desired capture aspect ratio is less than the sensor aspect ratio, then the zoom is equal to the desired capture aspect ratio. In some embodiments, the zoom may be an optical zoom or a digital zoom. Additionally, the zooming feature may be implemented, in some embodiments, so that it is transparent (i.e., not explicitly visible) to the user. In other words, the zoom feature may occur automatically and without the user being aware of the zoom. In other embodiments, the zooming may be made visible to the user so that he can disable the zoom or control the amount of zoom, if desired.

For example, in the embodiment illustrated in FIG. 6C, the sensor aspect ratio is 3:2, and the desired capture aspect ratio of the landscape image is 16:9. Because the sensor aspect ratio (3:2=3/2=1.5) is less than the desired capture aspect ratio (16:9=16/9=1.78), the zoom is equal to the sensor aspect ratio (1.5). Thus, image 610 of FIG. 6D is a 1.5× zoom, or magnification, of the image 608 exposed to the camera device's image sensor.

In some embodiments, if the user has previously zoomed the camera with the device positioned in portrait mode, and then switches to landscape mode, the previous portrait-mode zooming may be taken into consideration when calculating the amount of zoom needed for the landscape mode so that the field of view achieved in the landscape mode is consistent with that achieved by the previous zooming in the portrait mode. For example, if a user performs a 2× zoom with the camera device positioned in portrait orientation and then rotates the device to a landscape orientation, then the amount of zoom performed in the landscape orientation is calculated as the previous amount of zoom (2×) plus the zoom calculated for landscape mode based upon the sensor and capture aspect ratios. In considering the example in FIG. 6D, the total zoom, or magnification, would be the sum of the previous zooming (2×) and the calculated 1.5× zoom, in this case, a total magnification of 3.5×.

In accordance with 506 of FIG. 5A, after the zoom is achieved, the magnified image 610 is cropped 611 according to the capture aspect ratio to produce the cropped image 612 of FIG. 6E. The cropped image 612 may be adjusted or resized to produce the captured landscape image 614 of FIG. 6F. In accordance with the example embodiment illustrated in FIGS. 6E and 6F, the cropped image 612 and resulting landscape image 614 have a capture aspect ratio of 16:9; however, it should be appreciated that the image may be cropped to other dimensions. The captured image 614 may be resized, if needed, and displayed for playback on a device 616 as shown in FIG. 6G. It should be appreciated that, in some embodiments, the cropping operation 506 may be eliminated or combined with the zoom operation 504 by performing the zoom such that the resulting zoomed/magnified image maintains the desired capture aspect ratio.

In some embodiments, the zoom/magnification operation may be performed on the captured image (i.e., image 608), as discussed above with respect to FIGS. 6C-6F. In other embodiments, the zoom operation may be performed prior to capturing the first image (e.g., image 608), thereby producing a zoomed/magnified capture image (similar to image 610 of FIG. 6D) and eliminating the original capture image 608. For example, FIG. 5B illustrates an example flow chart 510 demonstrating one such embodiment wherein the zoom operation (step 512) is performed prior to capturing the first image (step 514). As discussed herein, the zoom may be an optical or digital zoom, and may be performed such that the amount of zoom or magnification is equal to the lesser of the sensor aspect ratio or desired capture aspect ratio. Additionally, the image captured in step 514 may, in some embodiments, be captured with the maximum resolution available for the sensor area at the sensor aspect ratio. In such embodiments, the subsequent cropping operation (step 516) may be performed on the zoomed/magnified captured image from step 514 with the maximum resolution achieved in step 514 and having the desired capture aspect ratio. FIG. 5C illustrates a flow chart 520 for a similar embodiment wherein the zoom operation and cropping operation are combined in step 522. In such embodiments, step 522 is achieved by performing the zoom followed by a crop (performed by the sensor/ISP) such that the resulting image has the desired capture aspect ratio. The resulting image is then captured in step 524 to produce the desired landscape image.

The image processing stages of FIG. 7 are discussed in greater detail below with reference to FIGS. 8A-8F, which each illustrate an image corresponding to the image processing stages provided in FIG. 7. Accordingly, the disclosed method for capturing a landscape image when the camera device is positioned in a portrait orientation is described below with reference to FIGS. 7 and 8A-8F. The embodiment discussed with reference to FIGS. 7 and 8A-8F corresponds to the embodiment generally illustrated above in FIG. 2A.

Referring briefly to FIG. 7, an image is captured in portrait orientation at 702. Referring now to FIG. 8A, image 802 illustrates an example scene that is to be captured by the camera device. The device 804 is positioned in portrait orientation as shown in FIG. 8B. Image 808 of FIG. 8C illustrates a first capture of the scene exposed to the device's image sensor. In the example illustrated in FIG. 8C, the sensor has a 3:2 aspect ratio, although it should be appreciated that sensors having other aspect ratios (e.g., 1:1) may be implemented. Image 808 corresponds to the sensor aspect ratio 202 in FIG. 2A.

In accordance with 704 of FIG. 7, image 808 is cropped 811 according to the capture aspect ratio and dimensions specified by the system (i.e., software, application, firmware, circuitry, etc.) processing the image to produce the cropped image 810 of FIG. 8D. In some embodiments, the cropping may be performed by the sensor, ISP, and/or CPU of the camera device. In the example embodiment illustrated in FIG. 8D, the cropped image 810 has an aspect ratio of 9:16; however, it should be appreciated that the system may specify that the image be cropped to other aspect ratios/dimensions. As a result of the device and sensor rotation shown in FIG. 8B, the image 808 and cropped image 810 appear rotated. Thus, the landscape aspect ratio of the cropped image 810 is inverted (i.e., the ratio is 9:16 instead of 16:9). It should be appreciated that, in some embodiments, the cropping operation 704 may be eliminated or combined with the image capture operation 702 by capturing the image such that the resulting image maintains the desired (inverted) capture aspect ratio.

In accordance with 706 and 708 of FIG. 7, the cropped image 810, which has an inverted landscape aspect ratio, is rotated by the ISP/CPU to the appropriate orientation, thereby producing landscape image 812 of FIG. 8E having the appropriate 16:9 aspect ratio. The landscape image 812 corresponds to the landscape image 204 in FIG. 2A. A preview of the landscape image 812 may be obtained by downscaling or resizing the captured landscape image 812 to the desired preview resolution so that it may be displayed on a device 814 as illustrated in FIG. 8F.

The landscape capture image 812 has a field of view that is identical to that of the landscape image 612 obtained via the image processing discussed above with respect to FIGS. 5A-5C and 6F. Moreover, and as discussed in greater detail below, the landscape image 812 has an increased field of view when compared to the landscape image 420 produced using the conventional method discussed above in connection with FIGS. 4A-4J.

When compared to the landscape image 420 produced using the conventional method discussed in connection with FIGS. 4A-4J, the landscape capture image 812 has an increased field of view. This is because the conventional method first crops the capture of the image 408 exposed to the sensor (to produce image 410, which is then resized, reformatted, etc. to produce image 412), and then again crops image 412 to produce the landscape image 420. In other words, the conventional method performs two cropping operations, each removing field of view from the image being cropped to produce the resulting image. However, the disclosed method only performs a single cropping operation to yield the landscape image. For example, as shown in FIGS. 8A-8F, image 808 is cropped to yield what is, in essence, a rotated landscape image 810. By eliminating the second cropping operation, the disclosed method maintains a larger field of view when compared to the conventional method, particularly in instances where the sensor aspect ratio is less than the desired capture aspect ratio. In instances where the desired capture aspect ratio is less than or equal to the sensor aspect ratio, the disclosed method maintains a landscape field of view that is equal to that produced using the conventional method.

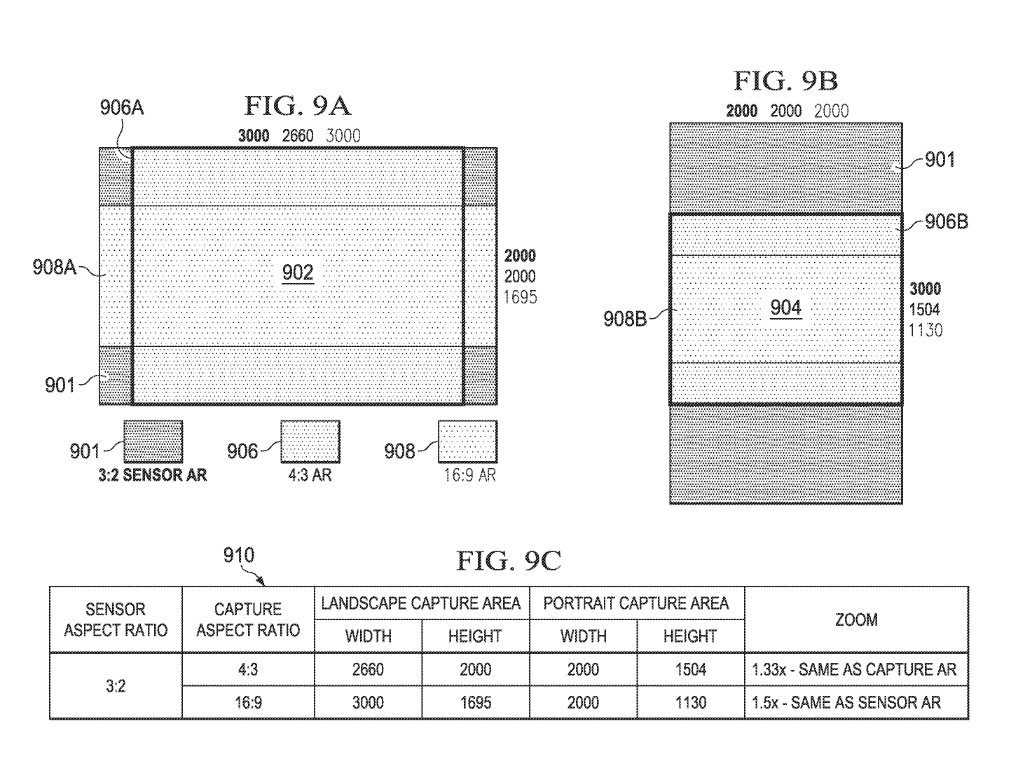

As mentioned above, the value of the zoom performed at 504 of FIG. 5A is determined based upon a comparison of the sensor aspect ratio and the desired capture aspect ratio of the landscape image. If the sensor aspect ratio is less than the desired capture aspect ratio, then the zoom is equal to the sensor aspect ratio. If the desired capture aspect ratio is less than the sensor aspect ratio, then the zoom is equal to the desired capture aspect ratio. In order to better describe the process of determining the zoom performed at 504, reference is made to FIGS. 9A-9C, which illustrate an example of a landscape capture area 902, a portrait capture area 904, and a chart 910 that corresponds to the zoom performed based upon an example of a desired capture aspect ratio and sensor aspect ratio. Reference is also made to the images of FIG. 6A-6G, which correspond to the various stages of FIG. 5A.

In the example illustrated in FIGS. 9A-9C, the image sensor has a 3:2 aspect ratio 901. Referring to FIG. 9A, the example landscape capture area 902 is comprised of a matrix of pixels having 3000 columns of pixels and 2000 rows of pixels. Thus, the landscape capture area 902 is capable of supporting a 4:3 landscape image 906A (i.e., a landscape image having a 4:3 capture aspect ratio) comprised of 2600 columns of pixels and 2000 rows of pixels. The landscape capture area 902 is also capable of supporting a 16:9 landscape image 908A (i.e., a landscape image having a 16:9 capture aspect ratio) comprised of 3000 columns of pixels and 1695 rows of pixels. Image 612 of FIG. 6E is an example of a 16:9 landscape image 908A.

Referring now to FIG. 9B, the example portrait capture area 904 is comprised of a matrix of pixels having 2000 columns of pixels and 3000 rows of pixels. Thus, the portrait capture area 904 is capable of supporting a 4:3 landscape image 906B comprised of 2000 columns of pixels and 1504 rows of pixels, and a 16:9 landscape image 908B comprised of 2000 columns of pixels and 1130 rows of pixels. Image 812 of FIG. 8E is an example of a 16:9 landscape image 908B.

In order to capture a landscape image on the landscape capture area 902 having a field of view that is identical to that of a landscape image captured on the portrait capture area 904, the landscape image captured in 502 of FIG. 5A (e.g., image 608) is zoomed in accordance with the foregoing description and as further illustrated by the chart 910 shown in FIG. 9C. For example, if the desired capture aspect ratio of the landscape image is 4:3, then a 1.33× zoom (i.e., a zoom equal to the desired capture aspect ratio) is performed on the image. This is because the desired capture aspect ratio (4:3) of the landscape image is less than the sensor aspect ratio (3:2). Accordingly, the field of view of the 4:3 captured landscape image 906A of the landscape capture area 902 corresponds to the field of view of the 4:3 landscape image 906B of the portrait capture area 904.

As another example, if the desired capture aspect ratio of the landscape image of 502 (e.g., image 608 of FIG. 6C) is 16:9, then a 1.5× magnification (i.e., a zoom equal to the sensor aspect ratio) is performed on the image. This is because the sensor aspect ratio (3:2) is less than the desired capture aspect ratio (16:9). Accordingly, the field of view of the 16:9 captured landscape image 908A of the landscape capture area 902 corresponds to the field of view of the 16:9 landscape image 908B of the portrait capture area 904.

As discussed above, conventional techniques for converting a captured portrait image into a landscape image include cropping the landscape image from the portrait image (see, for example, FIGS. 4H-4J). When compared to such techniques, the disclosed system and method significantly improve the field of view of a rendered landscape image captured when the camera device is positioned in portrait orientation, particularly in instances where the sensor aspect ratio is less than the capture aspect ratio.

For example, referring again to FIGS. 2A-2C, when the sensor aspect ratio is less than the capture aspect ratio, the landscape image 204 produced by the disclosed method has an increased field of view when compared to the landscape image 226 produced using the conventional method. In embodiments in which the capture aspect ratio is less than or equal to the sensor aspect ratio, the landscape image 204 has an identical field of view when compared to the landscape image 216 produced using the conventional method. This is illustrated below in Table 1, which provides a comparison of the actual percentages of the camera device image sensor capture area used in each of the techniques for various combinations of capture aspect ratios (Capture A.R.) and sensor aspect ratios (Sensor A.R.).

TABLE 1

| | | | % Sensor Area used | |
|---|---|---|---|---|
| | | % Sensor Area | in Portrait Mode | |
| | | used in Disclosed | Disclosed | Conventional |
| Capture A.R. | Sensor A.R. | Landscape Mode | Method | Method |
| 4:3 | 4:3 | 100 | 56 | 56 |
| | 16:9 | 75 | 42 | 42 |
| 3:2 | 4:3 | 88 | 50 | 39 |
| | 16:9 | 84 | 37 | 37 |
| 16:9 | 1:1 | 56 | 56 | 18 |
| | 5:4 | 70 | 45 | 22 |
| | 4:3 | 75 | 42 | 23 |
| | 3:2 | 84 | 37 | 27 |
| | 16:9 | 100 | 31 | 31 |

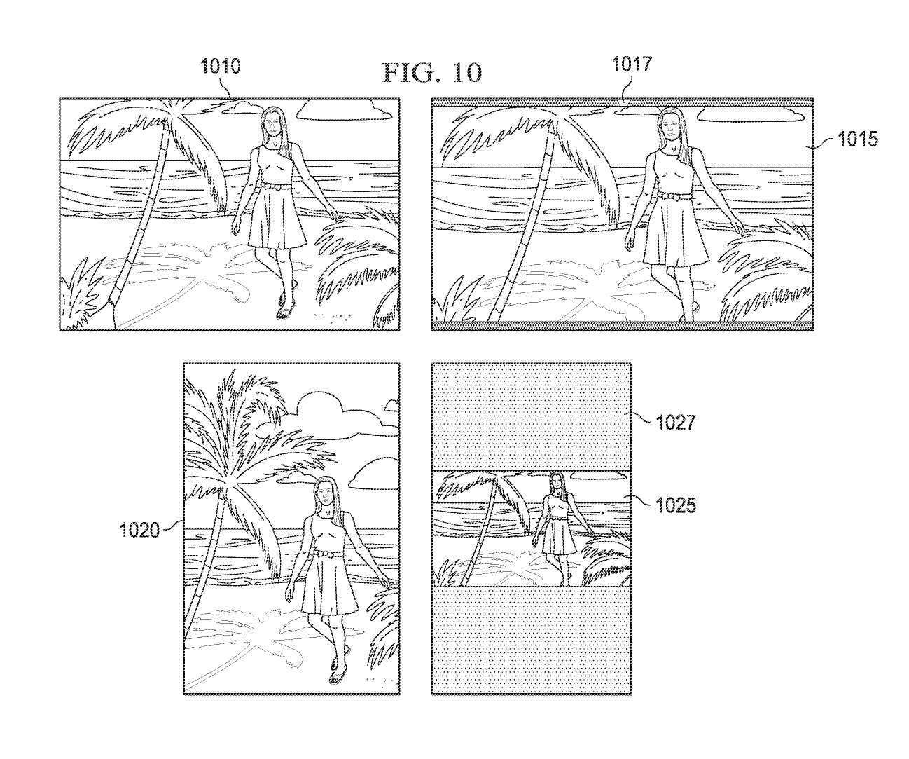

FIG. 10 illustrates, in both portrait and landscape orientations, an example of a scene exposed to a camera device image sensor and the landscape image produced in accordance with the disclosed method for generating a landscape image. Reference 1010 illustrates the scene exposed to the camera device image sensor when the camera device is positioned in landscape orientation, and reference 1015 illustrates the corresponding landscape image produced in accordance with the disclosed method and displayed on a landscape display 1017. Reference 1020 illustrates the scene exposed to the camera device image sensor when the camera device is positioned in portrait orientation, and reference 1025 illustrates the corresponding landscape image produced in accordance with the disclosed method and displayed on a portrait display 1027. In the embodiments illustrated in FIG. 10, the camera sensor has a sensor aspect ratio of 3:2, and the resulting landscape images 1015 and 1025 have a capture aspect ratio of 16:9. Furthermore, in accordance with the present disclosure, the two resulting landscape images 1015 and 1025 have identical fields of view.

Accordingly, the views shown by references 1017 and 1027 of FIG. 10 also illustrate how a single captured landscape image (i.e., image 1015 or image 1025) appears in accordance with the rotation of the display. For example, image 1015 illustrates how a landscape image captured in accordance with the present disclosure appears when the viewing display is oriented in landscape orientation, and image 1025 illustrates how a landscape image captured in accordance with the present disclosure appears when the viewing display is oriented in portrait orientation. In other words, references 1015 and 1025 can also represent the same captured landscape image displayed on the same display screen, with the display screen oriented in landscape orientation at 1017 and oriented in portrait orientation at 1027. Thus, by recognizing the orientation of the display screen (e.g., by using a gyroscope of the display device) and performing a display surface rescaling operation to properly display/orient the image for a particular orientation of the display, the display device can provide for seamless display across all orientations of the display device.

The foregoing description has provided by way of exemplary and non-limiting examples a full and informative description of one or more exemplary embodiments of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

What is claimed is:

1. A method for rendering a landscape image of a scene captured by a camera device, the method comprising:
operating in a first mode when the camera device is positioned in a portrait orientation, the first mode comprising:
cropping a first capture of the scene, the first capture having a first aspect ratio, to produce a first cropped image having a second aspect ratio defining a field of view of the landscape image, and
generating, from the first cropped image, the landscape image having the field of view defined by the first cropped image.

2. The method as set forth in claim 1, further comprising:
operating in a second mode when the camera device is positioned in a landscape orientation, the second mode comprising:
performing a zoom operation to produce a magnified view of the scene, the magnified view of the scene having the second aspect ratio; and
generating, from the magnified view of the scene, the landscape image having a field of view substantially equal to the field of view defined by the first cropped image.

3. The method as set forth in claim 2, wherein performing the zoom operation to produce the magnified view of the scene comprises:
magnifying a second capture of the scene, the second capture having the first aspect ratio, to produce a magnified image having a width equal to the width of the field of view defined by the first cropped image; and
cropping the magnified image to produce the magnified view of the scene having the second aspect ratio.

4. The method as set forth in claim 2, wherein generating the landscape image from the magnified view of the scene includes at least one member of a group that includes:
rotating the magnified view of the scene;
resizing the magnified view of the scene; and
outputting the landscape image.

5. The method as set forth in claim 2, wherein the magnified view of the scene has a magnification equal to the lesser of the first aspect ratio and the second aspect ratio.

6. The method as set forth in claim 2, wherein the magnified view of the scene has a magnification equal to the sum of:
a) a user-selected magnification; and
b) the lesser of the first aspect ratio and the second aspect ratio.

7. The method as set forth in claim 1, wherein generating the landscape image from the first cropped image includes at least one member of a group that includes:
rotating the first cropped image;
resizing the first cropped image; and
outputting the landscape image.

8. The method as set forth in claim 1, wherein the first aspect ratio is an aspect ratio of an image sensor of the camera device.

9. A method for rendering a landscape image of a scene captured by a camera device, the landscape image having a first field of view when the landscape image is captured with the camera device positioned in a portrait orientation, and having a second field of view when the landscape image is captured with the camera device positioned in a landscape orientation, wherein the first field of view is substantially equal to the second field of view, the method comprising:
operating in a first mode when the camera device is positioned in the portrait orientation, the first mode comprising:
cropping a first capture of the scene, the first capture having a first aspect ratio, to produce a first cropped image having a second aspect ratio and defining the first field of view, and
generating, from the first cropped image, the landscape image having the first field of view; and
operating in a second mode when the camera device is positioned in the landscape orientation, the second mode comprising:
performing a zoom operation to produce a magnified view of the scene, the magnified view of the scene defining the second field of view, wherein the second field of view is substantially equal to the first field of view, and
generating, from the magnified view of the scene, the landscape image having the second field of view.

10. The method as set forth in claim 9, wherein performing the zoom operation to produce the magnified view of the scene comprises:
magnifying a second capture of the scene, the second capture having the first aspect ratio, to produce a magnified image having a width equal to a width of the first field of view; and
cropping the magnified image to produce the magnified view of the scene having the second aspect ratio.

11. The method as set forth in claim 9, wherein generating the landscape image from the first cropped image includes at least one member of a group that includes:
rotating the first cropped image;
resizing the first cropped image; and
outputting the landscape image.

12. The method as set forth in claim 9, wherein generating the landscape image from the magnified view of the scene includes at least one member of a group that includes:
rotating the magnified view of the scene;
resizing the magnified view of the scene; and
outputting the landscape image.

13. The method as set forth in claim 9, wherein the magnified view of the scene has a magnification equal to the lesser of the first aspect ratio and the second aspect ratio.

14. The method as set forth in claim 9, wherein the magnified view of the scene has a magnification equal to the sum of:
a) a user-selected magnification; and
b) the lesser of the first aspect ratio and the second aspect ratio.

15. The method as set forth in claim 9, wherein the first aspect ratio is an aspect ratio of an image sensor of the camera device.

16. The method as set forth in claim 9, wherein the second aspect ratio is an aspect ratio of the landscape image.

17. One or more computer-readable media embodied with computer-executable instructions that, when executed by one or more processors, perform a computer-implemented method for rendering a landscape image of a scene captured by a camera device, the landscape image having a first field of view when the landscape image is captured with the camera device positioned in a portrait orientation, and having a second field of view when the landscape image is captured with the camera device positioned in a landscape orientation, wherein the first field of view is substantially equal to the second field of view, the method comprising:
operating in a first mode when the camera device is positioned in the portrait orientation, the first mode comprising:
cropping a first capture of the scene, the first capture having a first aspect ratio, to produce a first cropped image having a second aspect ratio and defining the first field of view, and
generating, from the first cropped image, the landscape image having the first field of view; and
operating in a second mode when the camera device is positioned in the landscape orientation, the second mode comprising:
performing a zoom operation to produce a magnified view of the scene, the magnified view of the scene defining the second field of view, wherein the second field of view is substantially equal to the first field of view, and
generating, from the magnified view of the scene, the landscape image having the second field of view.

18. The one or more computer-readable media of claim 17, wherein performing the zoom operation to produce the magnified view of the scene comprises:
magnifying a second capture of the scene, the second capture having the first aspect ratio, to produce a magnified image having a width equal to a width of the first field of view; and
cropping the magnified image to produce the magnified view of the scene having the second aspect ratio.

19. The one or more computer-readable media of claim 17, wherein generating the landscape image from the first cropped image includes at least one member of a group that includes:
rotating the first cropped image;
resizing the first cropped image; and
outputting the landscape image.

20. The one or more computer-readable media of claim 17, wherein generating the landscape image from the magnified view of the scene includes at least one member of a group that includes:
rotating the magnified view of the scene;
resizing the magnified view of the scene; and
outputting the landscape image.

21. The one or more computer-readable media of claim 17, wherein the magnified view of the scene has a magnification equal to the lesser of the first aspect ratio and the second aspect ratio.

22. The one or more computer-readable media of claim 17, wherein the magnified view of the scene has a magnification equal to the sum of:
a) a user-selected magnification; and
b) the lesser of the first aspect ratio and the second aspect ratio.

23. The one or more computer-readable media of claim 17, wherein the first aspect ratio is an aspect ratio of an image sensor of the camera device.

24. The one or more computer-readable media of claim 17, wherein the second aspect ratio is an aspect ratio of the landscape image.

25. A device for rendering a landscape image of a scene, the device comprising:
circuitry operable to determine an orientation of the device;
an image sensor operable to capture an image of the scene exposed to the image sensor, the captured image having a sensor aspect ratio; and
image processing circuitry operable in a first mode to:
crop the captured image to produce a first cropped image having a second aspect ratio and defining a first field of view, and
generate, from the first cropped image, the landscape image having the first field of view;
wherein the image processing circuitry is further operable in a second mode to:
perform a zoom operation to produce a magnified view of the scene, the magnified view of the scene defining the second field of view, wherein the second field of view is substantially equal to the first field of view, and
generate, from the magnified view of the scene, the landscape image having the second field of view,
wherein the image processing circuitry operates in the first mode when the device is positioned in a portrait orientation and operates in the second mode when the device is positioned in a landscape orientation.

26. The device of claim 25, wherein performing the zoom operation to produce the magnified view of the scene comprises:
magnifying the captured image to produce a magnified image having a width equal to a width of the first field of view; and
cropping the magnified image to produce the magnified view of the scene having the second aspect ratio.

27. The device of claim 25, wherein the circuitry operable to determine the orientation of the device includes at least one member from a group that includes:
a gyroscope; and
one or more computer-readable media embodied with computer-executable instructions that, when executed by one or more processors, perform a computer-implemented method for recognizing images in the scene exposed to the image sensor.

28. The device of claim 25, wherein generating the landscape image from the first cropped image includes at least one member of a group that includes:
rotating the first cropped image;
resizing the first cropped image; and
outputting the landscape image.

29. The device of claim 25, wherein generating the landscape image from the magnified view of the scene includes at least one member of a group that includes:
rotating the magnified view of the scene;
resizing the magnified view of the scene; and
outputting the landscape image.

30. The device of claim 25, wherein the magnified view of the scene has a magnification equal to the lesser of the sensor aspect ratio and the second aspect ratio.

31. The device of claim 25, wherein the magnified view of the scene has a magnification equal to the sum of:
a) a user-selected magnification; and
b) the lesser of the sensor aspect ratio and the second aspect ratio.

32. The device of claim 25, wherein the second aspect ratio is an aspect ratio of the landscape image.
